(19) United States
(12) Patent Application Publication
(10) Pub. No.: US 2017/0304873 A1
(43) Pub. Date: Oct. 26, 2017

(54) ELECTRIC PRESSURE WASHER

(71) Applicant: KARCHER NORTH AMERICA, INC., DENVER, CO (US)

(72) Inventors: CHARLES JOHN LUBY, HARDY, VA (US); ADAM BEARUP, LAKEWOOD, CO (US); TRENT GARNER, HIGHLANDS RANCH, CO (US); SHERI HUTHER, WESTMINSTER, CO (US); MICHAEL RASMUSSEN, DENVER, CO (US)

(73) Assignee: KARCHER NORTH AMERICA, INC., DENVER, CO (US)

(21) Appl. No.: 15/492,254

(22) Filed: Apr. 20, 2017

Related U.S. Application Data
(60) Provisional application No. 62/325,430, filed on Apr. 20, 2016.

(51) Int. Cl. B08B 3/02; B05B 7/24; B05B 7/00

(52) U.S. Cl. CPC B08B 3/026; B05B 7/2472; B05B 7/2443; B05B 7/0093; B08B 2203/0217; B08B 2203/0223

(57) ABSTRACT

An electric pressure washer includes an electric motor operably connected to a pump, one or more removable detergent tanks, a removable accessory bucket in which a spray gun, high pressure hose, and other accessories may be stored, and a foot pedal for facilitating operator control of one or more features of the electric pressure washer during use. The electric pressure washer may also include a folding handle for facilitating storage and transport.

### CROSS-REFERENCE TO RELATED APPLICATIONS

The present application claims the benefit of and, under 35 U.S.C. §119(e), priority to U.S. Provisional Application Ser. No. 62/325,430, entitled “Electric Pressure Washer.” The entire disclosure of the foregoing application is hereby incorporated by reference, in its entirety, for all that it teaches and for all purposes.

### FIELD

The present disclosure relates generally to pressure washers, and more specifically to electric pressure washers.

### BACKGROUND

Pressure washers use high pressure liquid, typically water, to clean surfaces such as driveways, decks, walls, and the like. Generally, pressure washers include an engine that provides power to a pump. The pump operates to provide high pressure fluid to a wand or a gun that includes a trigger mechanism that is actuated by the user to discharge the high-pressure fluid. Generally, the user squeezes the trigger with one hand and supports the discharge end of the gun with the other hand during use. During periods when high-pressure water is not required, the user releases the trigger and high-pressure water from the pump discharge is directed back to the pump intake to either recirculate, move to a holding tank or be discharged through a release port.

U.S. Pat. No. 5,277,208 to Mansur, which is hereby incorporated by reference in its entirety, discloses a multi-process power spray washer apparatus. The Mansur apparatus comprises a central washing chamber into which articles to be cleaned may be inserted, a high-power sprayer to spray cleaning solution into the central washing chamber at high pressure, a cleaning solution reservoir, and various components for removing contaminants from the cleaning solution. U.S. Pat. No. 8,057,681 to Daly et al., which is hereby incorporated by reference in its entirety, provides a similar disclosure. Both Mansur and Daly et al. fail to provide various novel features and devices of the present disclosure, including features related to electric pressure washers as shown and described herein.

U.S. Pat. No. 5,299,767 to Simpson, which is hereby incorporated by reference in its entirety, discloses a pressure washer frame having a gun valve and a hose rack. The pressure washer frame comprises a stop member connected to a conventional handle. A hose to which the pressure washing gun valve is connected may be coiled about the handle and held against slippage by the stop member. Simpson also describes a pair of longitudinally spaced cradles attached to the pressure washer frame, which support a pistol grip of the gun valve and a distal end of the gun valve, respectively. Simpson fails to disclose various novel features and devices of the present disclosure, including features related to electric pressure washers as shown and described herein.

U.S. Pat. No. 8,556,192 to Wise, which is hereby incorporated by reference in its entirety, discloses a portable pressure washer. The portable pressure washer of Wise comprises a tank assembly detachably mounted to the base. The tank assembly can be removed to fill water and solution tanks, then reattached to the base, which houses a liquid pump, an air compressor, and a rechargeable battery. Wise fails to disclose various novel features and devices of the present disclosure, including features related to electric pressure washers as shown and described herein.

U.S. Patent Application Publication No. US 2014/0119949 to Wischstadt et al., which is hereby incorporated by reference in its entirety, discloses a pressure washer with a folding handle. Before the handle can be folded, a user must manually loosen two nuts, one on each side of the handle, that are threadably attached to two carriage bolts, respectively. Once the nuts are loosened, an upper portion of the handle can be rotated forward and downward into a stowed position. A similar arrangement is described in Chinese Patent No. CN204247658U, which is hereby incorporated by reference in its entirety. Both Wischstadt et al. and Chinese Patent No. CN204247658U fail to disclose various novel features and devices of the present disclosure, including features related to electric pressure washers as shown and described herein.

Chinese Patent Application No. CN103658141A, which is hereby incorporated by reference in its entirety, discloses a high-pressure washer rack with a folding handle. A spring-loaded rod slidably mounted in grooves of metal plates mounted on each side of the folding handle, near the pivot point of the folding handle, is used to unlock the handle for folding and to lock the handle in a chosen position. Chinese Patent No. CN202962946U, which is hereby incorporated by reference in its entirety, discloses a pressure washer with a similar handle folding mechanism. Both of these references, however, fail to disclose various novel features and devices of the present disclosure, including features related to electric pressure washers as shown and described herein.

Chinese Patent No. CN201760420U, which is hereby incorporated by reference in its entirety, also discloses a pressure washer with a folding handle. An upper handle is pivotably mounted to a lower handle, and a positioning device mounted to one side of the upper handle comprises a pushrod that detachably engages the lower handle when the upper and lower handles are aligned. The positioning device can be disengaged from the lower handle to allow the handle to fold. Chinese Patent No. CN201760420U fails to disclose various novel features and devices of the present disclosure, including features related to electric pressure washers as shown and described herein.

Known pressure washers and similar devices are also disclosed in U.S. Pat. Nos. 2,919,491, 3,074,383, 3,648,968, 5,381,962; 5,784,754; 7,028,925; 7,406,739; 8,074,668; 8,496,188; 8,602,323; 8,739,815; 8,888,016; D621,565; D652,590; D726,382; D735,959; D739,715; and D740,501, and in U.S. patent application Ser. Nos. 14/573,993; 14/696,127; 15/009,511; 15/061,773; 15/043,188; 29/500,066; 29/517,538; 29/534,019; 29/534,020; 29/534,021; 29/544,129; 62/110,158; 62/115,857; 62/120,452; 62/128,609; 62/196,466; and 62/204,687, the disclosures of all of which are hereby incorporated by reference herein in full. As a skilled artisan will understand, these and other known pressure washers have numerous failings which could be addressed through features and controls, such as those disclosed herein.

### SUMMARY

There has been a long-felt and unmet need to provide an electric pressure washer comprising one or more of the various features and methods of the present disclosure. Such features include, for example, a high cord wrap facilitating easy storage of an electrical cord for the electric pressure washer while reducing or eliminating the need for an operator of the electric pressure washer to bend down while wrapping or unwrapping the electrical cord; the use of extruded metals in the product, with those metals designed to be both light and ergonomical so as to facilitate lifting and transport of the electric pressure washer; a removable detergent tank with an ergonomic design to facilitate tank removal (e.g. for refilling the tank with detergent, washing the tank after use); a removable bucket or other container for hose and accessory storage, which may be used, for example, to securely store a gun/lance system, and may be equipped with a drain to allow accumulated fluid to exit; a foot-activated switch for turning the electric pressure washer on and off or, in some embodiments, for controlling one or more other features of the pressure washer; and a folding handle, operable by depressing a single button, that allows the electric pressure washer to assume a compact shape for ease of transport and storage.

In one embodiment of the present disclosure, an electric pressure washer is provided, the electric pressure washer comprising an outer frame comprising a lower handle; an upper handle pivotably mounted to the lower handle; a handle joint for selectively locking the upper handle in an upright position or a folded position; a pump unit substantially contained within the outer frame, the pump unit comprising an electric motor and a water pump; a detergent tank, which may be removable, substantially contained within the outer frame; and an accessory bucket, which may be removable, substantially contained within the outer frame.

The handle joint may include a button that, when depressed, releases the upper handle for movement between the upright position and the folded position. The upper handle may include two substantially parallel members, each member having a first end pivotably mounted to the lower handle and a second end connected to a grip. The upper handle may also include two brackets, one mounted to each member of the upper handle nearer to the second end than the first end. The electric pressure washer may further include an electrical cord for connecting the electric motor to an external power source, the electrical cord including a plug, and the grip may include a blank female receptacle configured to receive the plug.

The removable detergent tank of the electric pressure washer may include a molded feature into which an operator's fingers may be inserted for removing the detergent tank from the outer frame. The electric pressure washer may include a plurality of removable detergent tanks. The electric pressure washer may further include a foot pedal for selectively powering the electric motor on or off. At least one of the outer frame and a member of the upper handle may be made of or include extruded metal. The accessory bucket or other container may include a drain.

In another embodiment of the present disclosure, an electric pressure washer includes a frame; an electric motor mounted to the frame; a water pump operably connected to the electric motor, the water pump having a low pressure inlet and a high pressure outlet; a water intake fitting for receiving water from an external source, the water intake fitting in fluid communication with the low pressure inlet; at least one removable detergent tank supported within the frame and defining an inner volume, the inner volume in selective fluid communication with the low pressure inlet; an accessory bucket; and a foot pedal supported by the frame and movable between a first position and a second position.

The at least one removable detergent tank may include a check valve for blocking detergent flow from the inner volume when the detergent tank has been removed from the frame. The electric pressure washer may include a plurality of removable detergent tanks, and a switch for selectively placing an inner volume of at least one of the removable detergent tanks in fluid communication with the low-pressure inlet. The accessory bucket may comprise at least one molded holster for containing a spray gun. The electric pressure washer may include a handle attached to the frame via a selectively pivotable connection, the handle comprising an accessory rack on which at least one accessory may be mounted. The electric pressure washer may further include a reel for storing a high-pressure hose, the reel rotatably mounted to the handle. The foot pedal may be selectively configured to control one of an unloader valve in fluid communication with the high-pressure outlet and a power switch.

In yet another embodiment of the present disclosure, a device for generating a stream of high pressure liquid includes a motor in operable connection with a pump, the motor and pump supported within a frame; a pair of wheels mounted coaxially near the bottom of the frame; a handle extending from the frame; a removable accessory bucket supported by the frame; at least one removable detergent tank supported by the frame; and a foot pedal connected to a switch. The switch may either turn the motor on and off, or open and close an unloader valve. The accessory bucket may include a drain, and the at least one removable detergent tank may include a check valve.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s).

FIG. 1 is a perspective view of two electric pressure washers according to one embodiment of the present disclosure; and

FIG. 2 is a perspective view of an electric pressure washer according to another embodiment of the present disclosure.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

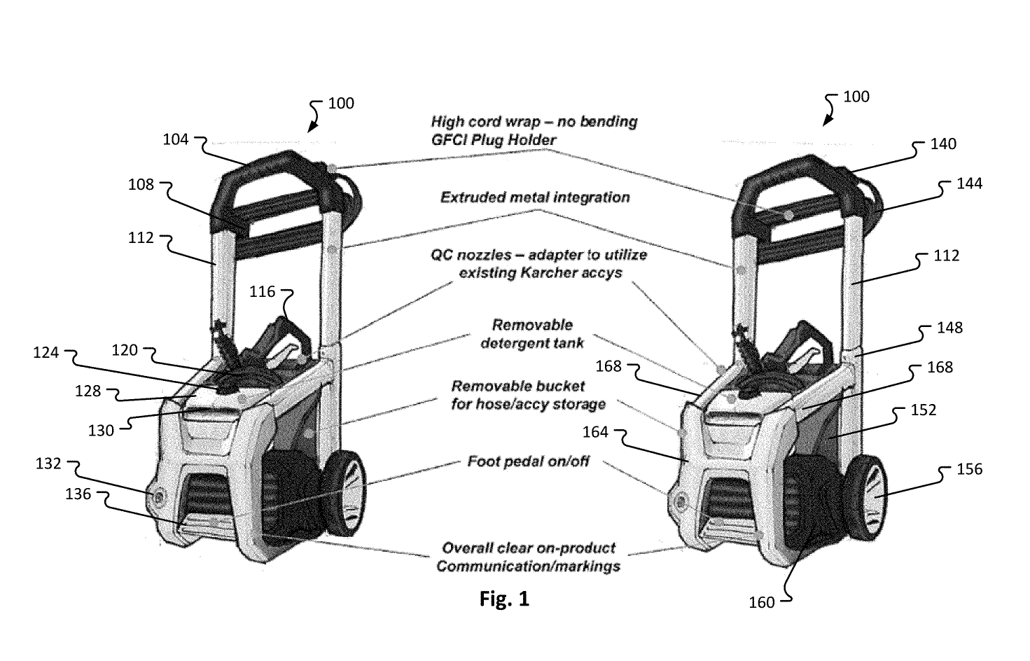

FIG. 1 shows two identical electric pressure washers 100 according to one embodiment of the present disclosure. Each pressure washer 100 includes a frame 164, a lower handle 148, and an upper handle 112. One or more of the frame 164, the lower handle 148, and the upper handle 112 may be made from extruded metal, in a shape that is designed both to minimize unnecessary weight (e.g. by incorporating hollow channels within the frame 164, the lower handle 148, and/or the upper handle 112) and to allow for comfortable gripping and lifting (e.g. by using diameters that can be readily grasped by an operator, and by using curves rather than sharp corners). For ease of manipulation, two horizontal and slightly downward sloping extruded members 168 of the frame 164, for example, can have a cross-sectional shape that is designed to make them comfortable to grab, and therefore facilitates lifting of the pressure washer 100 into a car or other vehicle for transport, or onto a hook, rack, or shelf for storage. The center of gravity of the pressure washer 100 may be located between the two members 168 to further enhance the ergonomics of the pressure washer 100 and facilitate lifting and transport of the same.

A grip 104 at the top of the upper handle 112 may be grasped or otherwise held by a user of the pressure washer 100 to push, pull, lift, or otherwise move or convey the pressure washer 100. The grip 104 may also be used to pivot the upper handle 112 (relative to the lower handle 148) into a folding position for storage, or to pivot the upper handle 112 into an upright position for use. In some embodiments, the grip 104 is comprised of plastic or rubber and is designed to reduce the transmission of vibration from the frame 164 to a user of the pressure washer 100, thus helping to reduce operator fatigue. The grip 104 may also be provided with one or more contours to improve an operator's ability to hold the grip 104, even when the operator's hands, the grip 104, or both are wet. Also in some embodiments, the lower handle 148, the upper handle 112, and the grip 104 are sized so that the grip 104 is at an ergonomic height for an average height operator. The diameter of the grip 104 may also be sized based on the average hand size of a target operator population, so that operators of the pressure washer 100 may easily grasp the grip 104.

Also, included in the pressure washer 100 are two brackets 108, one on each of the two parallel members of the upper handle 112. The brackets 108 are provided near the grip 104 (although the brackets 108 may, in some embodiments, be provided on the grip 104), and are used for storage of an electrical cord 144. More specifically, an electrical cord 144 may be wrapped around the brackets 108 when the electrical cord 144 is not in use, and unwrapped from the brackets 108 and plugged into an external power source to allow the electric power washer 100 to be operated at a distance from the external power source. In some embodiments, the grip 104 or the upper handle 100 comprises a blank female plug receptacle configured to receive the ground fault circuit interrupt (GFCI) plug 140 for storage. The inclusion of such a blank female plug receptacle reduces the risk of damage to the plug 140 when the plug 140 is not in use.

The brackets 108 may incorporate several design features to enhance their functionality and ease of use. First, the surface of the brackets 108 that primarily contacts the electrical cord 144 may be arcuate in shape, so as to prevent the electrical cord 144 from having to bend around corners, which bending could weaken and eventually damage the electrical cord 144. Second, each bracket 108 may comprise a flange on a surface opposite the upper handle 112 or grip 104, which flange may prevent the electrical cord 144 from sliding over an end of each bracket 108 and falling off. Third, each bracket 108 may be rotatably mounted to the upper handle 112 or the grip 104, and the flange may be provided only around a portion of the bracket 108. With this configuration, the brackets 108 can be placed in a first orientation in which the electrical cord 144 is secured on the brackets 108 between the flange and the upper handle 112 or the grip 104, and either or both brackets 108 may be placed in a second position in which the flanged portion of the brackets 108 is rotated out of the way of the electrical cord 144, which may then be easily slid off one or both the brackets 108. As a result, the operator does not have to unwrap the electrical cord 144 off the brackets 108 to use the same, but may instead simply and easily remove the entire electrical cord 144 from the brackets 108 at once.

Fourth, the brackets 108 may be mounted relatively high up on the pressure washer 100, in a horizontal rather than a vertical configuration, so that an operator can wrap an electrical cord 144 around the brackets 108 without having to bend over to reach one or both of the brackets 108.

While prior art pressure washers comprise cradles on which a spray gun and/or lance may be rested when not in use, the electric pressure washer 100 of the present disclosure comprises an accessory bucket 152, in which a spray gun 116, a high-pressure hose 120, and other accessories (including, for example, nozzles for the spray gun 116, wands or lances for attachment to the spray gun 116, rags, sponges, and other cleaning items) may be stored. The accessory bucket 152 may be configured with one or more molded holsters (or with any other form of separate compartments or dividers) to facilitate organization and storage of accessories therein, or the accessory bucket 152 may comprise a single, undivided receptacle. In some embodiments, the accessory bucket 152 may be provided with a drain, through which liquid that leaks out of a spray gun 116, a high-pressure hose 120, or another accessory, or that enters the accessory bucket 152 by any other means, may flow out of the accessory bucket 152 rather than accumulating therein. The use of an accessory bucket 152 rather than cradles such as those found in the prior art beneficially reduces the likelihood that a spray gun 116 will fall off the pressure washer 100 during transport, or if the pressure washer 100 is bumped, or in other situations.

In some embodiments of the present disclosure, a spray gun or fluid dispensing apparatus such as that disclosed in co-pending U.S. patent application Ser. No. 15/043,188 may be used in connection with a pressure washer 100 as described herein.

Additionally, the accessory bucket 152 may be removable from the pressure washer 100. Some benefits of the removability of the accessory bucket 152 include to facilitate washing of the accessory bucket 152 and removal of debris or other unwanted components therefrom. Additionally, an operator may maintain a plurality of accessory buckets 152, each with a different set of accessories stored therein. In such instances, one accessory bucket 152 may easily be swapped out for another accessory bucket 152 depending on the task at hand.

The pressure washer 100 further comprises a detergent tank 128, with a removable cap 124 that covers a filler aperture in the detergent tank 128. Detergent may be added to the tank 128 by removing the cap 124 and pouring detergent therein through the normally capped opening. The pressure washer 100 may or may not be operated with detergent. When the pressure washer 100 is operated with detergent, the pressure washer 100 may introduce the detergent to the primary liquid flow in a variety of ways. In some embodiments, the pressure washer 100 may include a tee mixer, an injection mixer, or another fluid mixer for mixing detergent from the tank 128 with a stream of water or other liquid provided from an external source before the liquid-detergent mixture enters the pump unit 160. Thus, the pressure washer 100 may be configured to route detergent from the tank 128 via a detergent supply line to such a fluid mixer. In other embodiments, the pressure washer 100 may be configured to route detergent from the tank 128 via a detergent supply line directly to a liquid supply line (e.g. a line through which water or other liquid is drawn from an external source to the pump), or to route detergent from the tank 128 via a detergent supply line directly to a low-pressure inlet of a pump in the pump unit 160. In other embodiments, the pressure washer 100 may utilize a vacuum created by the pump to siphon the detergent into the pump. In still other embodiments, a downstream chemical injector may be used to inject detergent into a discharge line, where it mixes with the high-pressure liquid prior to discharge thereof. The downstream chemical injector may utilize a separate pump for pumping detergent into the discharge line. For example, an injection system such as that described in co-pending U.S. patent application Ser. No. 15/061,773 may be used in some embodiments of the present disclosure. Further, mixing of detergent could occur at the nozzle of the discharge gun or wand.

The detergent tank 128, like the accessory bucket 152, is removable. In particular, the detergent tank 128 may include a molded feature 130 in a readily accessible location (e.g. near the top front of the tank, where it can be easily reached by an operator of the pressure washer 100). The molded feature 130 may be an ergonomic hand, partial hand, several finger or single finger grip allowing for easy removal of the detergent tank 128. In various embodiments, the molded feature 130 may comprise a lip, one or more finger holds, a cavity (of virtually any shape and configuration) into which a person's fingers may be inserted, an overhang underneath which one or more digits may be inserted or other feature as will be known to a person of skill in the art.

The removable detergent tank 128 comprises a port in a bottom portion thereof through which detergent may flow, through a detergent supply line, to a fluid mixer, liquid supply line, a low-pressure inlet of a pump, or directly into the pump. The removable detergent tank 128 may also comprise a check valve that prevents detergent from leaking out of the port when the tank 128 is removed from the pressure washer 100. When the tank 128 is replaced in the pressure washer 100, the check valve may automatically be displaced from a closed position to an open position, so that detergent may again flow through the port. In some embodiments, a plurality of detergent tanks 128 may be provided, together with a switch that allows an operator of the pressure washer 100 to easily select one or the other, or neither, of the two tanks 128. The switch may be configured to open and close the check valves in the tanks 128, or to operate one or more different valves provided in the detergent supply line to open and close the supply line to detergent flow from a given tank 128.

The pressure washer 100 further comprises a garden hose adapter or other intake fitting 132. The intake fitting 132 is connected to a source of water or other liquid, which water or other liquid is routed to the low-pressure inlet of the pump in the pump unit 160. In some embodiments, the incoming water or other liquid may be mixed with detergent from a detergent tank 128 before entering a port of the pump of the pump unit 160.

A foot pedal 136 provided on the front of the pressure washer 100 facilitates operator control of one or more features of the pressure washer 100. For example, the foot pedal 100 may be configured as an on/off switch for the main power of the pressure washer 100. Thus, when the foot pedal 136 is depressed a first time or moved to a first position, the pressure washer 100 may turn on, and when the foot pedal 136 is depressed a second time or moved to a second position, the pressure washer 100 may turn off. In some embodiments, the foot pedal 136 may additionally or alternatively control operation of an unloader valve for releasing built-up pressure on the high-pressure side of the pump unit 160. In gas-powered pressure washers, a foot pedal, such as the foot pedal 136, may be used to operate a pressure relief valve to facilitate starting the machine (as starting the engine is more difficult when high pressure side of the pressure washer is pressurized).

Although the foot pedal 136 is illustrated and described as being on the front of the pressure washer 100, the present disclosure encompasses the placement of the foot pedal 136 behind or on the side of the pressure washer 100. Also, though only a single foot pedal is described, multiple foot pedals could be used to facilitate operation of various aspects of the device.

The pump unit 160 comprises operating components of the pressure washer 100, including an electric motor and a pump. The electric motor may be powered by an external power source (e.g. by connecting the electrical cord 144 to a power outlet), and may be configured to receive electricity at, for example, 110 or 220 volts. The electric motor may generate anywhere from about 1 horsepower to about 7 horsepower, or more or less horsepower. In some embodiments, the electric motor may additionally or alternatively be powered by an on-board battery, which may also be included in the pump unit 160. Such a battery may be a nickel-cadmium battery, or a lithium-ion battery, or any other battery capable of powering the electric motor of the pump unit 160. Where the pump unit 160 includes a battery, the pump unit 160 may also comprise circuitry for recharging the battery, together with a port to which an external power source may be connected for recharging the battery. Alternatively, an electrical cord in electrical communication with the recharging or electrical components or other circuitry may be used to connect the pump unit 160 to an external power source.

The electric motor of the pump unit 160 may be a permanent magnet motor, a brushless motor, a switched reluctance motor, a cage or wound rotor induction motor, a torque motor, or an ironless/coreless rotor motor. The motor may be configured to operate on direct current or on alternating current. The pump unit 160 may comprise a transformer, a converter, and any other components needed to properly condition an incoming power signal for use by the electric motor. Additionally, the pump unit 160 may comprise an electronic speed control for varying the rotational speed of the electric motor.

The pump of the pump unit 160, which may be driven by the electric motor, draws low-pressure water (or other liquid) from an external source through the intake fitting 132 and into a low-pressure inlet. The liquid may or may not be mixed with detergent from the detergent tank 128 before or upon reaching the low-pressure inlet. The pump pressurizes the water (or other liquid), releasing it from a high-pressure outlet to a high-pressure hose such as the high-pressure hose 120. The water or other liquid flows through the high-pressure hose to a spray gun 116 or other release valve, where it may be selectively released at a high pressure. In some embodiments, detergent from the detergent tank 128 is injected into the pressurized liquid released from the high-pressure outlet. Also, in some embodiments the pressure washer 100 pressurizes the water up to between 1,000 PSI and 7,000 PSI. The pressure washer 100 may, in some embodiments, pressurize the water up to 2,000 PSI, or up to 4,000 PSI. The pump may be any suitable pump, as is known in the field by a skilled artisan.

The pressure washer 100 may be equipped with two wheels 156 rotatably and coaxially attached near the base of the lower handle 148, one on either side of the frame 164. (Only one wheel 156 is visible in FIG. 1.) The wheels may be made of any suitable material or combination of materials, including plastic or rubber, and may be sized so as to facilitate movement of the pressure washer 100 over not just paved surfaces, but also rough surfaces, such as unpaved roads and paths, dirt, gravel, and vegetated areas. The wheels 156 may be positioned so that the pressure washer 100 rests on a bottom portion of the frame 164 when the pressure washer 100 is in an upright position, but on the wheels 156 when the pressure washer 100 is titled backward. In this way, the pressure washer 100 can be easily conveyed, but will not roll away during use.

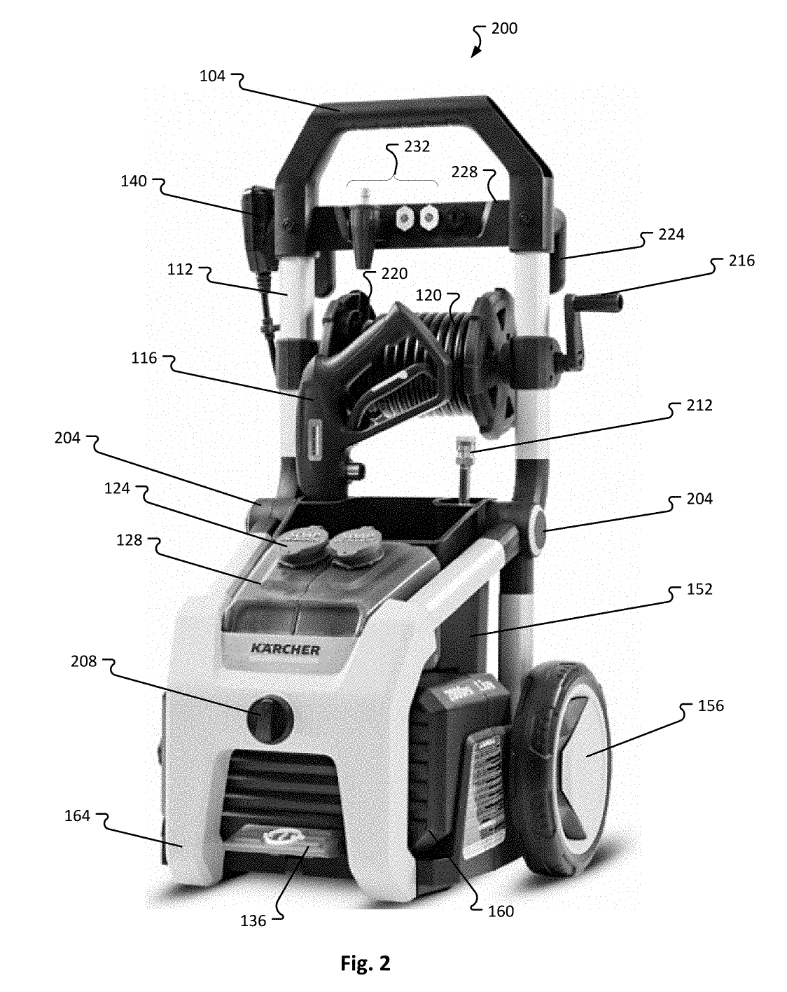

FIG. 2 is a perspective view of a pressure washer 200 according to another embodiment of the present disclosure. Many of the features and components of the pressure washer 200 are the same as or like the features and components of the pressure washer 100. For example, the pressure washer 200 also includes a grip 104; an upper handle 112; an accessory bucket 152 for holding accessories, such as a spray gun 116 and a lance 212; a high-pressure hose 120; a plurality of detergent tanks 128, each with a removable cap 124; a foot pedal 136; wheels 156; a pump unit 160; and a frame 164.

The pressure washer 200 also comprises several additional features. Visible in FIG. 2 are button-operated handle joints 204 that lock the upper handle 112 into an upright or a folded position. Upon depression of the central button in one or both joints 204, the handle joints 204 unlock, allowing the upper handle 112 to rotate forward and downward toward the detergent tanks 128, thus allowing the pressure washer 200 to be made more compact and thus more suitable for transport and storage. When the upper handle 112 is in the folded position, depression of the central button in one or both of the joints 204 unlocks the handle joints 204, thus releasing the upper handle 112 for rotation to an upright position. Upon reaching the upright position, the upper handle 112 locks into place. In some embodiments, a rod or other mechanism connects the handle joints 204 and allows the operator to actuate both joints 204 by depressing the central button on only one joint 204. In some embodiments, a button for actuating the handle joints 204 may be positioned elsewhere on the pressure washer 200, e.g., on the grip 104.

Also, visible in FIG. 2 is a detergent selector switch 208. The detergent selector switch 208 allows an operator of the pressure washer 200 to select no detergent, the left detergent tank 128, or the right detergent tank 128. The detergent selector switch 208 may be mechanically configured to selectively actuate a check valve in each of the left and right detergent tanks 128. Alternatively, the detergent selector switch 208 may be associated with another valve that controls whether detergent from a tank 128 may pass into a detergent supply line, from which it eventually is mixed with the water or other liquid received through the intake fitting 132, as described above.

The pressure washer 200 further comprises a hose reel 220 for storage of the high-pressure hose 120. The hose reel 220 is equipped with a handle 216 for reeling in the high-pressure hose 120. In some embodiments, the reel 220 may be equipped with a locking mechanism for selectively locking the reel 220, to ensure that the reel 220 does not unwind inadvertently. In some embodiments of the present disclosure, a reel system such as that described in U.S. Provisional Patent Application No. 62/196,466 (which is incorporated herein in its entirety) may be used as the hose reel 220.

An accessory rack 228 of the pressure washer 220 is also shown in FIG. 2. The accessory rack 228 includes one or more mounts for small accessories 232, such as nozzles for the spray gun 116/lance 212. While these accessories may also be kept in the accessory bucket 152, the inclusion of an accessory rack 228 on which the smaller accessories 232 may be mounted helps to ensure that such accessories are always readily available, and also avoids the eventuality that an operator would have to rummage through the contents of the accessory bucket 152 to locate the small accessories 232.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items. The use of abbreviations, words, or phrases indicating the presentation of an example—including “for example,” “by way of example,” “such as,” and “e.g.,”—is not intended to be limiting, but rather is it indicate that what follows is an example of how one or more features of the present disclosure may be arranged, configured, or otherwise implemented.

What is claimed is:

1. An electric pressure washer comprising:
an outer frame comprising a lower handle;
an upper handle pivotably mounted to the lower handle;
a handle joint for selectively locking the upper handle in an upright position or a folded position;
a pump unit substantially contained within the outer frame, the pump unit comprising an electric motor and a water pump;
a removable detergent tank substantially contained within a substantially defined envelope by the outer frame; and
a removable accessory bucket substantially contained within an envelope substantially defined by the outer frame.

2. The electric pressure washer of claim 1, wherein the handle joint comprises a button that, when depressed, releases the upper handle for movement between the upright position and the folded position.

3. The electric pressure washer of claim 1, wherein the upper handle comprises two substantially parallel members, each member having a first end pivotably mounted to the lower handle and a second end comprising a grip.

4. The electric pressure washer of claim 3, wherein the upper handle comprises two brackets, one mounted to each member of the upper handle nearer to the second end than the first end.

5. The electric pressure washer of claim 5, further comprising an electrical cord for connecting the electric motor to an external power source, the electrical cord comprising a plug, wherein the grip further comprises a blank female receptacle configured to receive the plug.

6. The electric pressure washer of claim 1, wherein the removable detergent tank comprises a molded feature into which an operator's fingers may be inserted for removing the detergent tank from the outer frame.

7. The electric pressure washer of claim 1, further comprising a plurality of removable detergent tanks.

8. The electric pressure washer of claim 1, further comprising a foot pedal for selectively powering the electric motor on or off.

9. The electric pressure washer of claim 1, wherein at least one of the outer frame and a member of the upper handle comprises extruded metal.

10. The electric pressure washer of claim 1, wherein the accessory bucket comprises a drain.

11. An electric pressure washer, comprising:
a frame;
an electric motor mounted to the frame;
a water pump operably connected to the electric motor, the water pump having a low-pressure inlet and a high-pressure outlet;
a water intake fitting for receiving water from an external source, the water intake fitting in fluid communication with the low-pressure inlet;
at least one removable detergent tank supported within the frame and defining an inner volume, the inner volume in selective fluid communication with the low-pressure inlet;
an accessory bucket; and
a foot pedal supported by the frame and movable between a first position and a second position.

12. The electric pressure washer of claim 11, wherein the at least one removable detergent tank comprises a check valve for blocking detergent flow from the inner volume when the detergent tank has been removed from the frame.

13. The electric pressure washer of claim 11, further comprising a plurality of removable detergent tanks and a switch for selectively placing an inner volume of at least one of the removable detergent tanks in fluid communication with the low-pressure inlet.

14. The electric pressure washer of claim 11, wherein the accessory bucket comprises at least one molded holster for containing at least a portion of a spray gun.

15. The electric pressure washer of claim 11, further comprising a handle attached to the frame via a selectively pivotable connection, the handle comprising an accessory rack on which at least one accessory may be mounted.

16. The electric pressure washer of claim 15, further comprising a reel for storing a high-pressure hose, the reel rotatably mounted to the handle.

17. The electric pressure washer of claim 11, wherein the foot pedal is selectively configured to control one of an unloader valve in fluid communication with the high-pressure outlet and a power switch.

18. A device for generating a stream of high pressure liquid, the device comprising:
a motor in operable connection with a pump, the motor and pump supported by and substantially enveloped within a frame;
a pair of wheels mounted coaxially near the bottom of the frame;
a handle extending from the frame;
a removable accessory bucket supported by the frame;
at least one removable detergent tank supported by the frame and substantially enveloped within the frame; and
a foot pedal connected to a switch.

19. The device of claim 18, wherein the switch either turns the motor on and off or opens and closes an unloader valve.

20. The device of claim 18, wherein the accessory bucket comprises a drain and the at least one removable detergent tank comprises a check valve.
